(19) United States
(12) Patent Application Publication
(10) Pub. No.: US 2003/0129943 A1
(43) Pub. Date: Jul. 10, 2003

(54) Apparatus and method for link adaptation of packet data service on satellite systems

(76) Inventors: Yunsang Park, Rockville, MD (US); Doug Wasson, Olney, MD (US); Xiang Chen, Gaithersburg, MD (US)

Correspondence Address: Hughes Electronics Corporation, Patent Docket Administration, Bldg. 1, Mail Stop A109, P.O. Box 956, El Segundo, CA, 90245-0956, US

(21) Appl. No.: 10/023,777

(22) Filed: Dec. 18, 2001

(51) Int. Cl. H04B 7/185

(52) U.S. Cl. 455/13.4; 455/522

(57) ABSTRACT

A system and method is provided for adapting communications links in a satellite system. A quality parameter of a communications link is continuously monitored, wherein the link provides satellite-based packet data service to a user terminal. The method further provides for reducing a short-term sensitivity of the quality parameter such that a modified quality parameter results. An operating parameter of the link is adapted based on the modified quality parameter. By adapting the operating parameter, transmission throughput can be optimized according to the unique channel environment of each user without sacrificing reliability.

### CROSS REFERENCES TO RELATED APPLICATIONS

This patent document relates to U.S. patent application Ser. No. 09/231,071, filed on Jan. 14, 1999, of Barnhar et al. which is incorporated herein by reference.

### BACKGROUND OF THE INVENTION

1. Technical Field

The present invention generally relates to communication systems. More particularly, the invention relates to a system and method for adapting communications links in a satellite-based packet data service.

2. Discussion

As the demand for information and personalized data increases, the importance of providing effective wireless communication services has become readily apparent. Generally, in order to use communication services to provide personalized data to one or more end-users, the service must be structured to be compatible with the type of data being delivered. For example, voice data, multimedia and packetized Internet Protocol (IP) data all have characteristics that directly affect the design of the communications link. To further complicate matters, market factors indicate a rapid movement toward an integrated communication service wherein all types of personalized data are seamlessly provided to the end user. It is well documented that the service must be structured to be compatible with the type of data being delivered. For example, voice data, multimedia and packetized Internet Protocol (IP) data all have characteristics that directly affect the design of the communications link. Additionally, market factors indicate a rapid movement toward an integrated communication service wherein all types of personalized data are seamlessly provided to the end-user link quality.

Traditionally, voice-based networks have been “circuit-switched” to provide either one-way (such as broadcast or multicast) or two-way communications. Circuit-switching involves establishing a continuous communication service between two participants by defining a channel over which the communications take place. The channel may include forward and reverse links that typically maintain the same path throughout the communication. Two-way circuit-switched networks therefore simultaneously assign forward and reverse links between the participants, such that the path between the participants is known in both directions. The circuit-switched approach has been particularly suited for wireless communications where management of the communications links is paramount to maintaining an acceptable quality level. For example, power level management, which is critical to spread spectrum modulation techniques such as code division multiple access (CDMA) is significantly improved with the continuous transmission of power level information between participants over well-defined and known channels. However, circuit-switched networks are inefficient because the link is maintained permanently or for a specified period of time. For example, a link with a specific bandwidth may be established, but there can be prolonged periods of time when information is not being communicated over the link. This is especially the case in situations where traffic is bursty.

While much consideration has been given to the above systems and techniques with regard to wireless voice communications, certain difficulties remain with respect to other types of data. For example, networks that transfer IP data operate on the packet-switched concept, which is quite different from circuit switching. Specifically, when communications are established between two participants in a packet-switched network, the forward and reverse links are independently assigned. Thus, in a satellite communication system, the radio resources of the forward and return links are allocated independently and are therefore much more difficult to manage. In fact, link adaptation has not been defined for packet-switched satellite-based data services as a result of this difficulty. Furthermore, the traffic pattern of packet data services is bursty by nature, which can contribute to short-term channel variations such as such short-term fading.

It is therefore desirable to optimize the use of radio resources in a satellite-based packet data service such that the communication link is adequately utilized based on the unique channel environment of each user.

### SUMMARY OF THE INVENTION

The above and other objectives are substantially achieved by a system and method for managing communications links in accordance with the principles of the present invention. A quality parameter of a communications link is continuously monitored, where the link provides satellite-based packet data service to a user terminal. The method further provides for reducing a short-term sensitivity of the quality parameter such that a modified quality parameter results. An operating parameter of the link is adapted based on the modified quality parameter. By adapting the operating parameter, transmission throughput can be optimized according to the unique channel environment of each user without sacrificing reliability.

In another aspect of the invention, a method and system for participating in a communications link is provided. The method includes the step of receiving bursts from a forward link where the forward link transfers packet data from a satellite-base network. A signal quality measure (SQM) is generated such that the SQM characterizes a forward link channel quality. The method further provides for transmitting a signal quality indicator report (SQIR) over a reverse link based on the SQM where the reverse link transfers packet data to the satellite-base network.

Further in accordance with an embodiment of the present invention, a system and method for participating in a communications link is provided. The method includes the step of receiving a power attenuation request (PAR) from a forward link, where the forward link transfers packet data from a satellite-based network. A transmitted power level is adjusted based on the PAR. The method further provides for transmitting a power attenuation notification (PAN) over a reverse link, where the reverse link transfers packet data to the satellite-based network.

In another aspect of the invention, a system and method employing a satellite access station (SAS) is provided. The SAS includes a packet base station subsystem and a network switching subsystem. The packet base station subsystem monitors quality parameters of a plurality of communications links. The links provide a satellite-based packet data service to a plurality of user terminals within a coverage area of one or more geosynchronous satellites. The network switching subsystem provides a switching interface between the packet base station subsystem and a packet-switched network. The packet base station subsystem adapts operating parameters of the links based on the quality parameters.

### BRIEF DESCRIPTION OF DRAWINGS

The various aspects, advantages and novel features of the present invention will be more readily comprehended from the following detailed description when read in conjunction with the appended drawings, in which:

FIG. 1 is a block diagram of an example of a method for managing a communications link in accordance with an embodiment of the present invention;

FIG. 2 is a diagram showing an example of a two-way communication service in accordance with an embodiment of the present invention;

FIG. 3 is a block diagram of an example of a satellite access station in accordance with an embodiment of the present invention;

FIG. 4 is a diagram showing an example of an approach for obtaining a signal quality indicator report in accordance with an embodiment of the present invention;

FIG. 5 is a block diagram of an example of an error vector magnitude calculation with decision feedback;

FIG. 6 is a plot showing an example of mean signal to noise ratio estimation performance in accordance with one embodiment of the present invention;

FIG. 7 is a plot showing an example of standard deviation of signal to noise ratio estimation performance in accordance with an embodiment of the present invention;

FIG. 8 is a plot of a unit step function modeling a sudden change of input values in accordance with an embodiment of the present invention;

FIG. 9 is a plot showing an example of the conversion speed of a filter with various filter coefficients in accordance with an embodiment of the present invention;

FIG. 10 is a diagram showing an example of measurement ranges for various code rates in accordance with an embodiment of the present invention;

FIG. 11 is a plot demonstrating an example of bit error rate performance in accordance with an embodiment of the present invention;

FIG. 12 is a diagram demonstrating temporary block flow overlap in accordance with an embodiment of the present invention;

FIG. 13 is a diagram demonstrating an example of an approach to obtaining a power attenuation notification in accordance with an embodiment of the present invention;

FIG. 14 is a plot of an example of averaging filter maintenance in accordance with an embodiment of the present invention;

FIG. 15 is a plot demonstrating an example averaging coefficient in accordance with an embodiment of the present invention;

FIG. 16 is a plot demonstrating an example of a filter response to a unit step input in accordance with an embodiment of the present invention; and

FIG. 17 is a block diagram of an example of a satellite access station in accordance with on embodiment of the present invention.

### DETAILED DESCRIPTION OF THE PREFERRED EMBODIMENTS

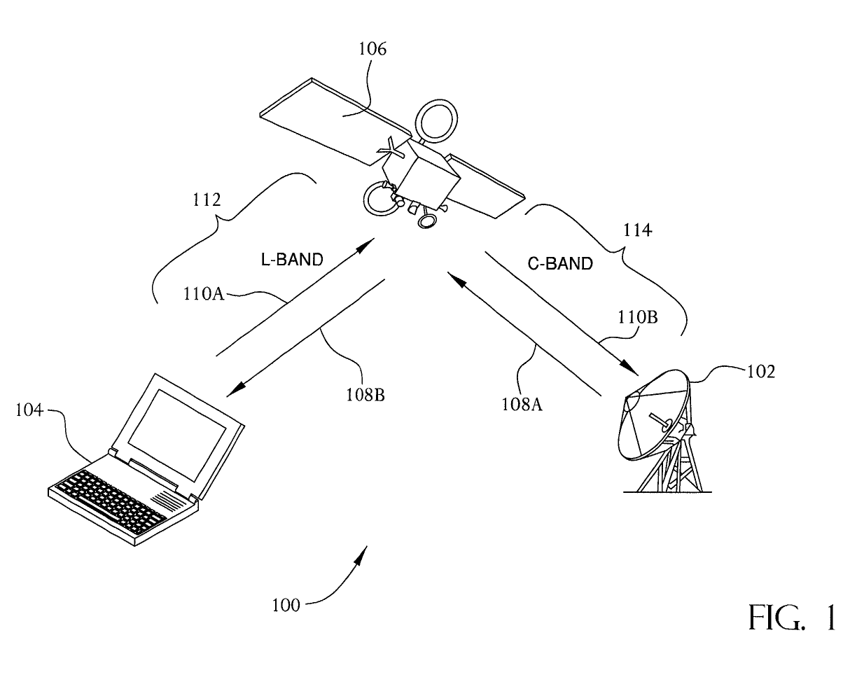

FIG. 1 depicts an exemplary two-way communication system 100 in accordance with an embodiment of the invention. Communication system 100 comprises a satellite access station (SAS) 102, a user terminal 104, a satellite payload 106, forward links 108A and 108B and reverse links 110A and 110B. The user terminals (UT) 104 are scattered throughout the packet data service area, and each user terminal 104 experiences unique channel conditions. Link adaptation is therefore implemented on a terminal-by-terminal basis where each user terminal 104 operates as a passive element for the link adaptation mechanism. The user terminal 104 collects all the required information for the link adaptation mechanism and reports the information back to the SAS 102. The satellite pay load 106 routes the data between the user terminal 104 and the SAS 102 as appropriate.

The satellite payload 106 is a satellite and can be a stationary satellite, a high earth orbit satellite (HEO), a low earth orbit satellite (LEO), a mid-orbit satellite (MEO), and the like. It will be appreciated by those skilled in the art that other types of satellites can be substituted and still fall within the scope of the present invention.

Specifically, FIG. 1 depicts two radio interfaces between the user terminals 104 and the SAS 102. More specifically, a user interface 112 is established between the user terminals 104 and the satellite pay load 106, while a feeder link interface 114 is established between the satellite payload 106 and the SAS 102. The user interface 112 has an operational frequency band of 1.525 GHz to 1.559 GHz for the forward link 108B and 1.625 GHz to 1.6605 GHz for the return link 110A. Thus, the user terminal's 104 bandwidth is allocated anywhere within these frequencies, and as the quality of the allocated link changes, link adaptation optimizes the appropriate operating parameters. Similarly, the feeder link interface 114 has an operational frequency band of 3.4 GHz to 3.7 GHz for the forward link 108A, and 6.424 GHz to 6.575 GHz for the return link 110B.

The SAS 102 can be viewed as the active element for the link adaptation mechanism. That is, the SAS 102 receives the required information from each user terminal 104, determines the appropriate link adaptation parameters, and sends the decisions to each user terminal 104. The invention of FIG. 1 can be implemented in many subsystems of the SAS 102 either directly or indirectly.

An embodiment of communication system 100 operates in the following manner to manage a communication link, the invention is preferably implemented in a satellite-based system, wherein the communication system uses a constellation of satellites in a geostationary orbit. The communication system 100 provides a plurality of radio transmitters/receivers such as user terminal 104 with packetized data such as internet content. It can be seen that the invention generally provides for continuously monitoring a quality parameter of the link. As already noted above, the link provides a satellite-based packet data service to the user terminal 104. The user terminal's 104 short-term sensitivity to the quality parameter is reduced such that a modified quality parameter results. Specifically, the operating parameter of the link is adapted to meet the operating conditions of the link based on the modified quality parameter.

Since the link is adapted based on the quality parameter, the packet data service has an enhanced level of quality with regard to conventional approaches. As will be discussed in greater detail below, the link can be either a forward link (i.e. transferring packet data from the SAS 102 to the user terminal 104), or a reverse link (i.e., transferring packet data from the user terminal 104 to the SAS 102). Furthermore, the quality parameter and the operating parameter will vary depending on the type of link being adapted. Nevertheless, the present invention provides a solution to the above-described difficulties associated with packet-switched link adaptation.

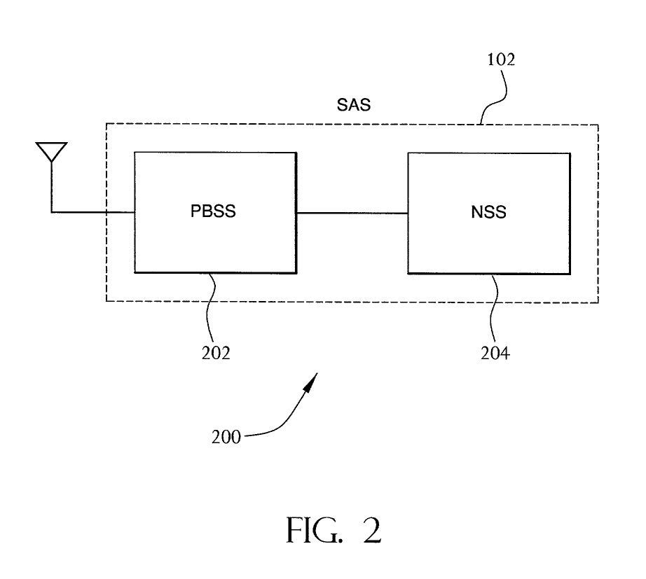

FIG. 2 depicts a block diagram of the SAS 102 in accordance with an embodiment of the invention. Specifically, the SAS 102 preferably comprises two components, a packet based station subsystem (PBSS) 202 and a network switching subsystem (NSS) 204. The PBSS 202 monitors the quality parameters of the plurality of communication links, where the links provide a satellite-based packet data service to a plurality of user terminals 104 within a coverage area of 1 or more geosynchronsis satellites. The NSS 204 provides a switching interface between the PBSS 202 and the packet-switched network (not shown). The PBSS 202 adapts operating parameters of the links based on the quality parameters. Thus, link adaptation is primarily implemented in the PBSS 202. As will be discussed in greater detailed below, the operating parameters primarily enable management of a variable code rate as well as a closed loop return link power control with regards to user terminal assignment and consumption. The PBSS 202 determines signal quality measures for return link bursts and requests measurement reports in support of forward link adaptation. The PBSS 202 can, therefore, include a packet modem management controller (PMC) (not shown) and a packet radio channel unit (PRCU) (not shown) to fully implement link adaptation.

It will be appreciated by those skilled in the art that the present invention can be applied to both forward links and reverse links. It will also be appreciated that certain operating parameters are not changed during a given assignment, also known as a temporary block flow (TBF), while others are. Table 1 below summarizes operating parameter treatment in relation to TBF.

TABLE 1
Link Parameters in a Temporary Block Flow (TBF)

| Link | Initially Determined | Adaptively Changed |
|---|---|---|
| Forward | Bandwidth, code rate, power | |
| | level | |
| Return | Bandwidth, code rate, initial | Power level |
| | power level | |

Table 1 shows that the bandwidth, code rate and power level parameters remain the same for the forward link. However, for the return link, the power level is adaptively changed. That is, the power level is changed in response to the quality of the transmission environment.

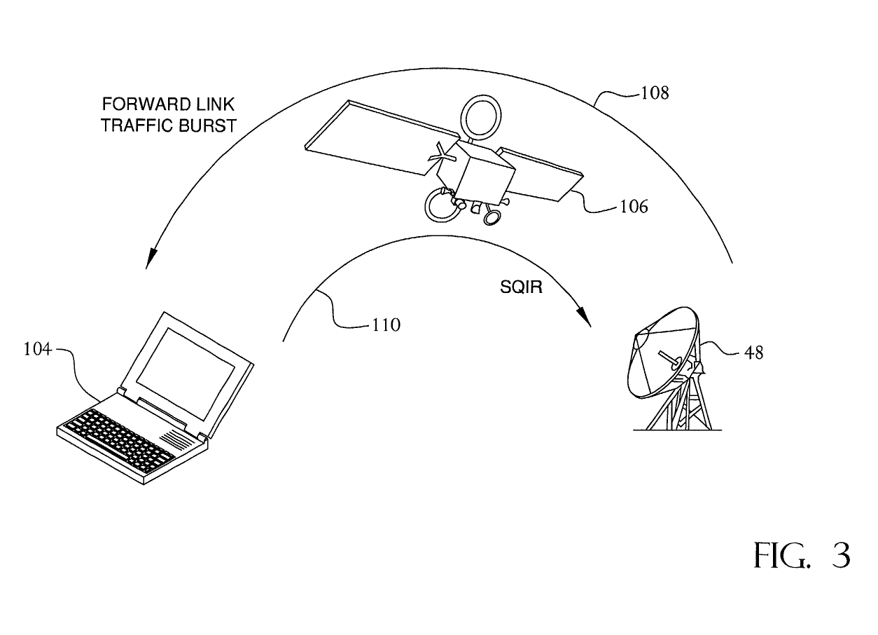

The invention will now be discussed in terms of forward link adaptation where the quality of a forward link is improved. Specifically, a signal burst is received from a reverse link and an instantaneous signal quality indicator report (SQIR) is extracted for use by the forward link (see FIG. 3). Thus, in the case of forward link adaptation, the quality parameter is the SQIR obtained from the reverse link 110 wherein the SQIR characterizes the forward link channel quality. As previously discussed above, there is no change to the bandwidth, code rate or power level parameters of future signal bursts to accommodate the link quality.

The user terminal 104 participates in the adaptation of the forward link by receiving bursts from the reverse link and generates a signal quality measure (SQM) such that the SQM characterizes the forward link channel quality. The SQM measures the average bit energy per noise density (E_{bt}/N₀) over the corresponding signal burst. The user terminal 104 calculates the average of the measured SQM's about every eight seconds after sending an SQIR to the SAS 102. The SQM is therefore based on instantaneous SQM's as given by the equation 1:

SQM_{avg}=E(SQMⱼ), (1)

Where “E” is the expectation operator. When the user terminal 104 reports the forward link signal quality measured, the user terminal 104 encodes the SQM_{AVG} to a SQIR. Specifically, the SQM_{AVG} is encoded into the SQIR in accordance with European Telecommunications Standards Institute (ETSI) document GMR-1 05.508, which is incorporated herein by reference. The encoded SQIR is then converted into a binary format. It should be noted that the SQIR can be transmitted via either a return link traffic burst or a return link control burst. One message format for the SQIR is given by ETSI document GMR-1 4.560, wherein the ETSI document GMR-1 5.508 defines the message.

It should be noted that the estimate of SQM is based on the error vector magnitude (EVM or the EVM with a decision feedback out algorithm. If the estimated signal to noise ratio (SNR) is low enough that the SQM estimate is performed in the non-linear region, then linearization is performed as described below.

In general, the EVM with decision feedback algorithm gives a better estimation performance than the EVM method in the low SNR region. Considering that multiple code rates can be used and the target operating point of the minimum code rate is as low as a 3.5 (dB), the preferred signal estimation method for the signal burst is the EVM with decision feedback algorithm.

The EVM values are generated as follows:

Given a set of N received symbols:

μ: the estimated mean level of received symbols,

σ²(n): the estimated variance in level for each demodulated symbol, where n=0, 1, 2, 3, 4 . . . , N−1.

$$EVM = \sqrt{\frac{1}{N} {\sum }_{n = 0}^{N - 1} {σ}^{2} ( n )} / {μ}^{2} \\ EVM ( dB ) = - 20 * {log}_{10} ( EVM ) \qquad ( 2 )$$

This is an estimate of the ratio of the error in each sample to the estimated mean over all symbols (measured in the power domain).

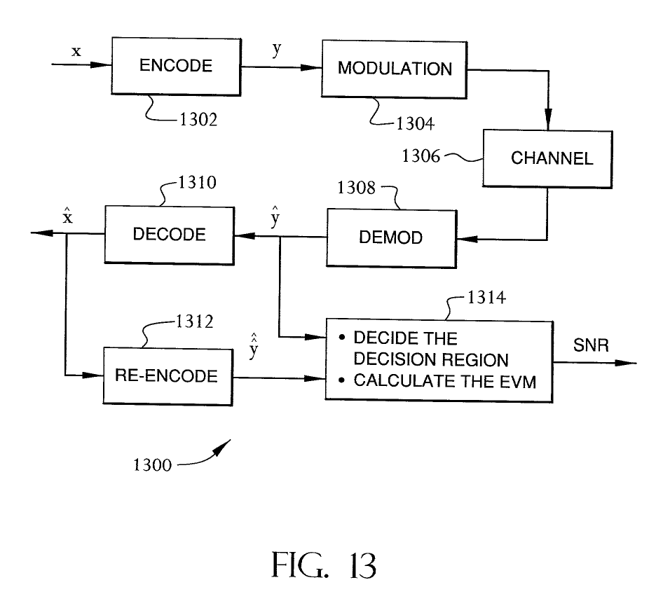

The EVM with a decision feedback algorithm is an extension of the EVM calculation. In this scheme, the mean and variance of the EVM are estimated with more accurate decision region information after a decoding. FIG. 13 shows a block diagram of a transmitter/receiver 1300 equipped with the EVM with decision feedback algorithm. The transmitter/receiver 1300 processes signal bursts according to the following equation and steps:

Given a set of N received samples:

After the demodulation, the estimated demodulated signal vector, ŷ, is created, in which ŷ=[ŷ₁, ŷ₂, . . . , ŷ₁] and ŷₗ=ŷ_{Il}+jŷ_{Qi}, where i=1,2 . . . , N

After re-encoding process, the re-encoded signal vector, \hat{\hat{y}}, is created, in which \hat{\hat{y}}=[\hat{\hat{y}}₁, \hat{\hat{y}}₂, . . . , \hat{\hat{y}}_{N}] and \hat{\hat{y}}ᵢ=\hat{\hat{y}}_{Ii}+j \hat{\hat{y}}_{Qi}, where i=1,2 . . . , N

Using \hat{\hat{y}}, create the decision region vector, D=[D₁, D₂, . . . , D_{N}]. For the QPSK modulation,

$${D}_{i} = \{ \begin{matrix} 1 , if {y}^{\hat{\hat{}}} i = ( 1 , 1 ) \\ 2 , if {y}^{\hat{\hat{}}} i = ( - 1 , 1 ) \\ 3 , if { y}^{\hat{\hat{}}} i = ( 1 , - 1 ) \\ 4 , if { y}^{\hat{\hat{}}} i = ( - 1 , - 1 )\end{matrix} \\ where i = 1 , 2 … , N \qquad ( 3 )$$

Perform the EVM calculation for samples having the same D₁ value. After the calculation of the EVM within each decision region, these values are averaged. The EVM calculation is the same as described previously above with respect to equation 1.

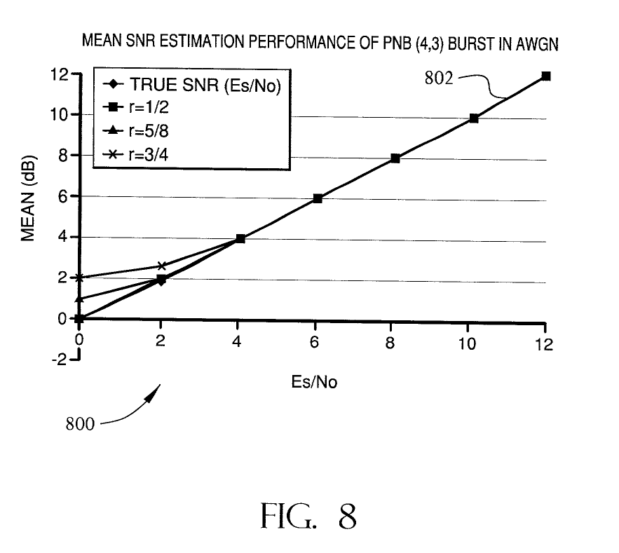

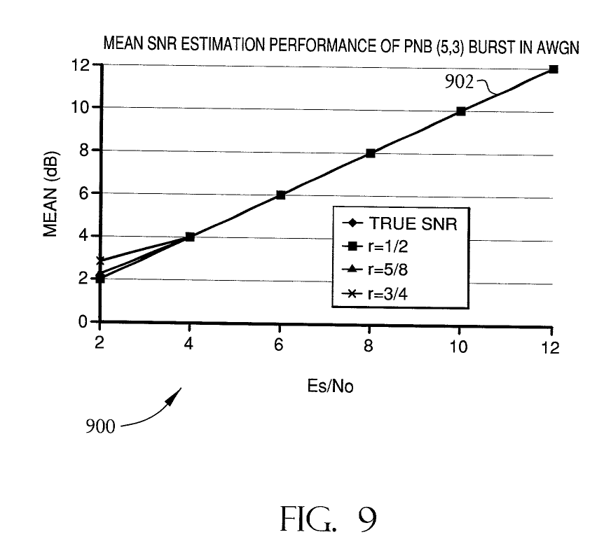

FIGS. 8 and 9 show mean and standard performance plots 802 and 902, respectively of the SNR estimation when the EVM with decision feedback algorithm is used. It should be noted that these figures show the Eₛ/Nₒ based SNR, which is 3 dB higher than the E_{bt}/Nₒ based measurement since certain systems use only QPSK as the modulation scheme.

As depicted in graph 800, the performance of the SNR estimation for the low code rate is better than that of the higher code rate. The improvement is due to the fact that the EVM with decision feedback algorithm uses the decoding information. Therefore, the method employing more powerful coding gives better SNR estimation performance.

Graph 900 shows the standard deviation of the SNR estimation performance at plot 902. It will be appreciated that the standard deviations for all code rates are lower than 0.4 dB if the Eₛ/Nₒ is above 4 dB (E_{bt}/Nₒ>1 dB). The SNR estimation for plot 902 is slightly better than that of plot 802 because the signal burst for the 902 plot contains larger symbols for the SNR estimation.

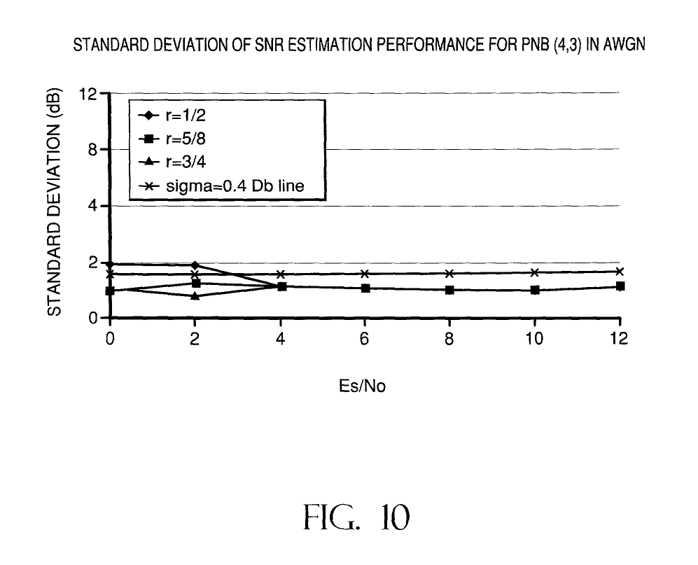

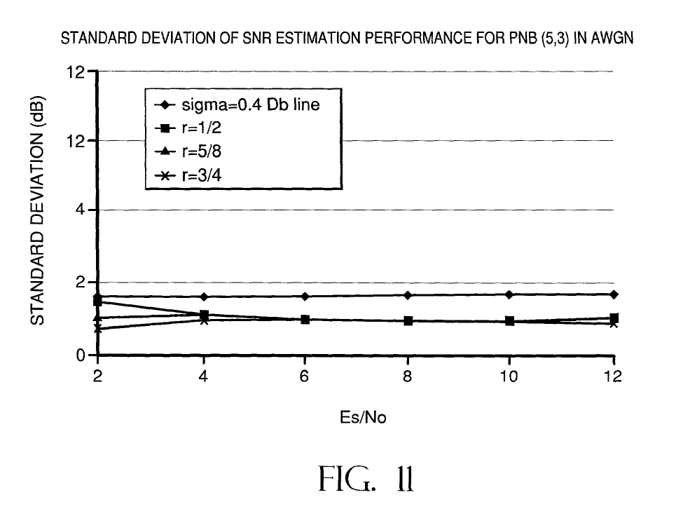

FIGS. 10 and 11 respectively show the standard deviation for FIGS. 8 and 9. Furthermore, FIGS. 8-11 include Additive White Gaussian Noise (AWGN) condition.

Two transformations of the raw EVM values occur during processing. Firstly the values are converted to dBs. Secondly, the estimates are linearized to extend the range of link adaptation effectiveness. Both of these tasks can be performed simultaneously using a lookup table approach. The code shown below in Table 2 illustrates the results of this process.

TABLE 2

| | |
|---|---|
| | REAL FUNCTION snr_to_dbs (x) |
| | REAL x, map (−20:20), offset |
| | INTEGER ind_low, ind_high, n |
| C | Data in the following array define the expected SNR measurements given actual levels from −20 to +20 dB Es/No. |
| C | Note that these were obtained from a simulation, by |
| C | (a) setting the Es/No level, |
| C | (b) performing an average in the dB domain, and |
| C | (c) transforming back to the absolute (linear power) domain. |
| C | Note also, that these values depend on the gain of the receive path, and the noise figure. |
| | DATA map/ |
| | 1 0.0210, 0.0212, 0.0212, 0.0213, 0.0214, 0.0215, 0.0217, 0.0220, 0.0222, 0.0225, |
| | 1 0.0231, 0.0236, 0.0243, 0.0251, 0.0262, 0.0277, 0.0296, 0.0317, 0.0349, 0.0389, |
| | 1 0.0437, 0.0504, 0.0587, 0.0703, 0.0847, 0.1037, 0.1277, 0.1596, 0.2000, 0.2511, |
| | 1 0.3154, 0.3975, 0.5002, 0.6287, 0.7915, 0.9976, 1.2554, 1.5800, 1.9903, 2.5070, |
| | 1 3.1536/ |
| C | Method is to find the 2 indices that the value ‘x’ lies between, and linearly interpolate between them to get a result |
| | in dB's. |
| | ind_low=−20 |
| | DO n=−19, 20 |
| | IF (x.GT.map(n)) THEN |
| | ind_low=n |
| | END IF |
| | END DO |
| | ind_high=ind_low+1 |
| | offset=(x-map (ind_high))/(−map(ind_high)+map(ind_low)) |
| | snr_to_dbs=ind_high − offset |
| | IF (snr_to_dbs .LT. −20.) snr_to_dbs−−20. |
| | END |

The code provides one approach to the lookup table steps. The approach uses 1 dB steps and linear interpolation between them. It will be appreciated by those skilled in the art that other approaches can be taken without departing from the spirit and scope of the invention.

Returning now to the operation of the forward link in terms of SQIR, it can be seen that once the instantaneous SQIR has been extracted, the SQIR is filtered in accordance with the following equation:

SQIR_{new} _{_{—}}_{avg}=αSQIRₖ+(1−α)SQIRₖ+(1−α)SQIR_{old}_{_{—}}_{avg} (4)

The above equation is preferably a simple single pole reclusive filter. However, the filter coefficient, “α”, should be selected carefully, so that the filter can react with reasonable speed. The above equation can be written as follows:

SQIR_{new}_{_{—}}_{avg}=αSQIRⱼ+α(1−α)SQIRⱼ₋₁+α(1−α)²SQIRⱼ₋₂+α(1−α)³ SQIRⱼ₋₃+ (5)

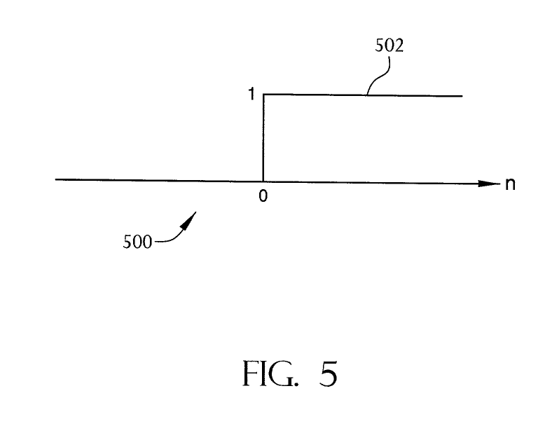

In order to select the “α”, the following objectives are established: 90% point should be reached at the N-samples after a sudden change of input values. A sudden change of the input values can be molded as a unit step function 500 as shown in FIG. 5.

Assuming that the step input is applied at N samples before, then the above equation becomes:

$${SQIR}_{new\_avg} = α + α ( 1 - α ) + {α ( 1 - α )}^{2} + {α ( 1 - α )}^{3} + Λ + \\ {α ( 1 - α )}^{N - 1} \\ = α \{ ( 1 - {( - α )}^{N - 1} ) / ( 1 - ( 1 - α ) ) \} = 1 - {( 1 - α )}^{N - 1} \qquad ( 6 )$$

In order for the SQIR_{new}_{_{—}}_{avg} to be the 90% of the new value, the equation (6) should be:

0.9=1−(1−α)^{N-1} (7)

Therefore, the coefficient, “α”, should be as follows:

α=1−(1−α)^{(1/(N-1))} (8)

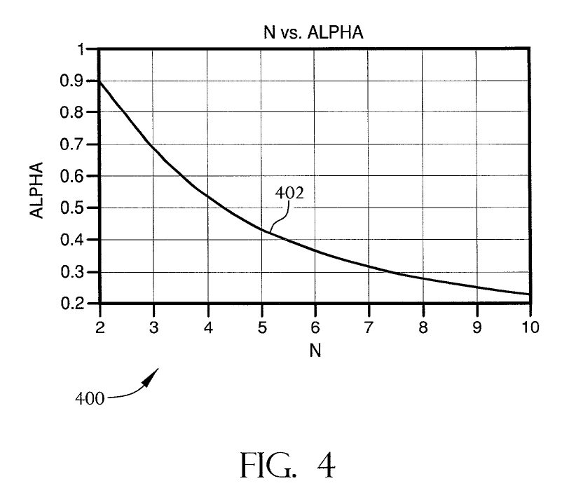

FIG. 4 shows “α” with regard to various N values in plot 402. The code rate of the forward link burst remains unchanged during a TBF. However, if there is a sudden change of the channel quality, most likely due to the incorrect selection of the code rate, the change should be reflected in the code rate selection for the next TBF. Therefore, in order to determine the number of samples required to reach the 90% of the changed value, N, the mean duration of the forward link TBF should be considered. If the SQIRnew_avg value in equation (4) reaches the 90% of the newly changed input value, SQIRⱼ, before the start of new TBF, then the newly selected code rate for the next TBF should reflect the change of the channel.

For the transmission control protocol (TCP) packet the average flow duration is between 12-19 seconds and the user datagram protocol (UDP) packet varies from 10-18 seconds with time-of-day variation. Since some overhead is required at the lower layer, it is assumed that the mean forward link TBF duration is 20 seconds in this calculation. Assuming that the inactive period between two consecutive TBF is 4 seconds, the interarrival time of the TBF is 24 seconds.

Assuming a 24-second duration of an interarrival time, the number of SQIRs expected during a TBF is about 3. Therefore, the default value of α is selected 0.7. It should be note that this value should be configurable at the network according to the traffic pattern.

Conclusively, the coefficient of the recursive filter of the SQIR in the network is as follows:

$$\begin{matrix}α = 1 , & if {SQM}_{old\_avg } does not exist \\ = 0.7 , & Otherwise .\end{matrix} \qquad ( 9 )$$

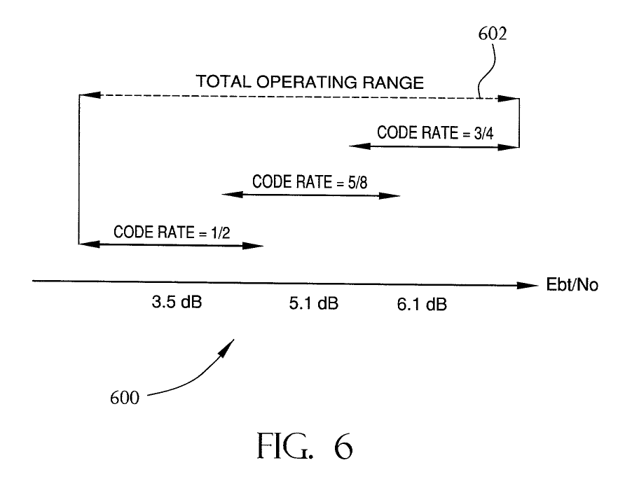

Even if the network sends the forward link bursts with a targeted operating point, the received signal quality of the burst measured in the UT 104 varies widely according to the user's channel condition. The diagram 600 of FIG. 6 shows the range of the received signal quality of the forward link bursts.

It can therefore be seen that each code rate has different operating ranges. The total monitoring range of the UT 104 should cover from the minimum measurable point of the code rate ½ to the maximum measurable point of the code rate ¾. This range is defined as the Total Measurement Range (TMR) 602.

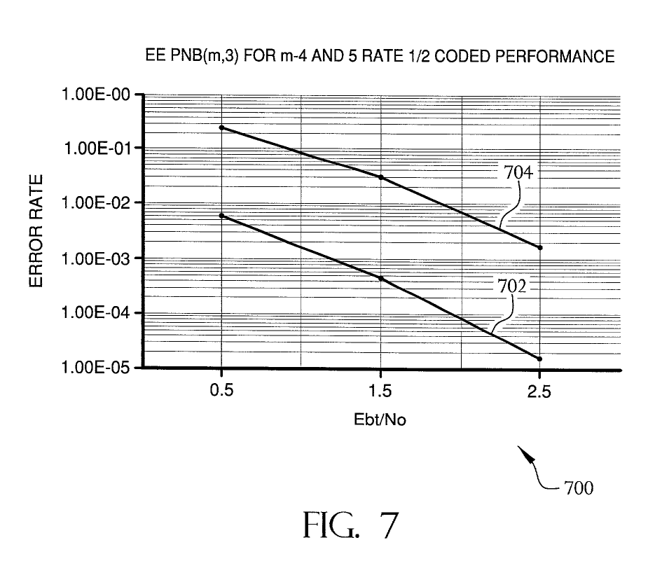

The lowest measurable point of the TMR 602 can be derived from the bit error rate (BER) performance of the point at the code rate r=½. When the signal quality of the received burst is 3 dB lower than the target operating point, 3.5 dB, then the coded BER is about 6*10⁻³ and the corresponding frame error rate (FER) is about 25% as shown in plot 702 of FIG. 7. This point is defined as the lowest point of the measurement range. It should be noted that plot 702 shows the theoretical BER performance corresponding to the various E_{bt}/N₀ conditions after a compensation of a 1.5 dB implementation margin.

The highest measurable point of the TMR can be set to 3 dB above of the highest code rate's target operating point, 6.1 dB which is plot 704. However, considering the possibility of future a higher modulation schemes, which typically need higher E_{bt}/Nₒ operating points, about 3.4 dB extra range is added in the upper TMR. Therefore, TMR is from 0.5 dB to 12.5 dB.

An important parameter to determine the size of the SQIR value is the quantization step size. Given TMR, by increasing the quantization accuracy, a SQIR size should also be increased.

The quatization step size can be derived from the budget of the total SQIR error. There are basically two sources of SQIR error. These devices are the UT's measurement and the SQIR quantization.

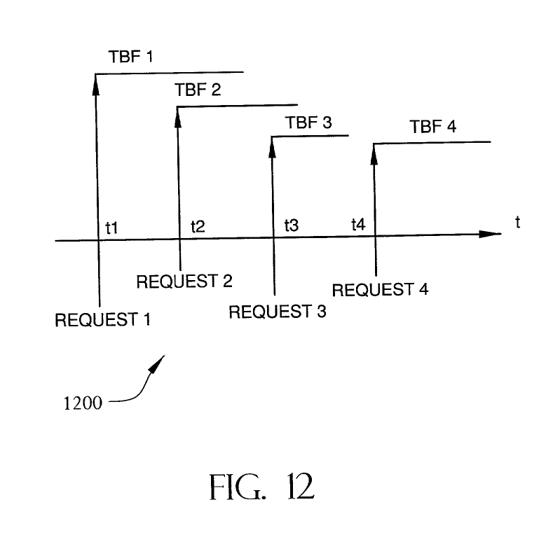

As previously discussed, although the bandwidth, code rate and power level are adapted, link adaptation is not performed on a temporary block flow (TBF) basis. Rather, link adaptation is performed on a terminal-by-terminal basis. Thus, even if a certain UT 104 has multiple concurrent TBFs in the same direction, the link operating parameters, such as code rate and power level, would be the same for all the concurrent TBFs. FIG. 12 shows the details at TBF diagram 1200. In this figure, it is assumed that multiple concurrent TBFs are active in the same directional link.

As shown in diagram 1200, each TBF will start with an initial request procedure. With the initial request of TBF 1 created at t1, the link parameters are determined. Using these parameters, the packet data is transmitted. However, if a resource request is created in time, t2, and TBF 2 is created at the same time, the network will not calculate the forward link operating parameters again since there is an existing TBF 1 in the same direction. Therefore, the network simply assigns the old link parameters to TBF 2 if it belongs to the same UT 104.

It should be noted that the link parameters are selected when a new assignment is established preferably if there is no existing TBF on the same directional link. No consideration is given to whether an assignment exists for the opposite directional link.

The code rate selection for both the return link (discussed below) and forward link is performed at the SAS 102 based on the history of the channel performance. These performances are stored in the recursive filter in the SAS 102 in the form of the SQM_{new}_{_{—}}_{avg} for the return link and the SQIR_{new}_{_{—}}_{avg} for the forward link.

When the code rate selection procedure is performed, the SAS 102 does not measure nor rely on the signal quality of the resource request message, such as Random Access Channel (RACH), Packet Random Channel (PRACH), or Packet Associated Channel (PACCH) due to the following reasons:

Firstly, the power radiation for a single signal burst is not consistent. For example, the power radiation range for a PRACH or RACH varies between −2 dB and +3 dB from the target radiating point, which is 5 dBW of swing range (see the ETST Document GMR-1 05.505, which is incorporated herein by reference).

Secondly, signal quality measurements are inaccurate. For example, since RACH or PRACH is carried on single 31.25 KHz carrier, the accuracy of the SNR estimation is worse than that of the conventional packet burst without link adaptation, which is typically carried on 4*31.25 KHz or 5*31.25 KHz carriers in certain systems.

When the SAS 102 determines a forward link TBF, if the history of the forward link quality, SQIR_{new}_{_{—}}_{avg}, is available (not a null value), then it calculates the distances from the nominal operating point, E_{bt}/N₀)ᵢ_{_{—target}}, to the measured channel quality, E_{bt}/N₀)ᵢₘₜ, as follows:

d₁=SQIR_{new}_{_{—}}_{avg}−(E_{bt}/N₀)_{1—}target,−η_{dn} (10)

where i=1, 2, 3 and each i represents r=½, r=⅝, and r=¾, respectively. Also, η_{dn}, in the above equation is the forward link adaptation margin. Initially, this value is set to 0.4 dB, which is the twice of the measurement error of the single normal burst. However, this value shall be configurable in the SAS for the future. The code rate is selected such that the distance, d₁, is positively minimized.

The invention will now be described in terms of the reverse link. As previously discussed the return link channel quality is estimated using a power attenuation notification (PAN) and power attenuation request (PAR) concept.

The PAR is a request (command) communicated by the receive end to the transmit end designating the transmit power level indicated by the value of the PAR field in which to transmit a signal. The PAN is a notification from the transmit end that it is now sending at the link level designated by the value of the PAN.

The values of the PAR and PAN field are described in terms of decibel attenuation with respect to a maximum transmit power level. The fields are designated as:

Power attenuation request (PAR)=Pₘₐₓ−PMR (11)

Power attenuation notification (PAN)=Pₘₐₓ−PMN (12)

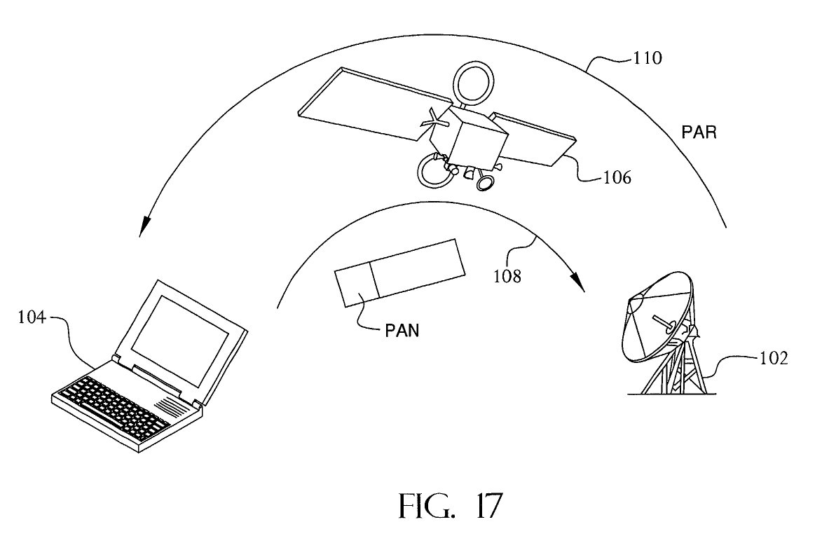

The SAS 102 does not necessarily need to know the value of Pmax as it can work exclusively with PAR and PAN. The PAN message is preferably created by each UT 104 and multiplexed into the traffic burst (see FIG. 17).

A-6-bit PAN value is included in every PUI field of the return link traffic burst. The PAN value is varied from 0 to 24 (dB) with 0.4 dB of step size. The detailed encoding methodology of the PAN is described in ETSI document, GMR-1 05.508, which is incorporated herein by reference.

Upon receiving a return link burst, the network or SAS 102 measures the average signal quality, (E_{bt}/Nₒ), of the corresponding burst, SQM. Thus, the monitored quality parameter is the PAN/SQM combination discussed above. A signal burst is received on the reverse link and the instantaneous PAN is extracted. The instantaneous SQM is also generated during this process.

The network filters the quality parameters to reduce short-term sensitivity. Specifically, the network maintains two averaging filters for the return link power control algorithm as follows:

SQM_{new}_{_{—}}_{avg}=βSQMⱼ+(1−β) SQM_{old}_{_{—}}_{avg} (13)

PAN_{new avg}=βPANⱼ+(1−β) PAN_{old}_{_{—}}_{avg} (14)

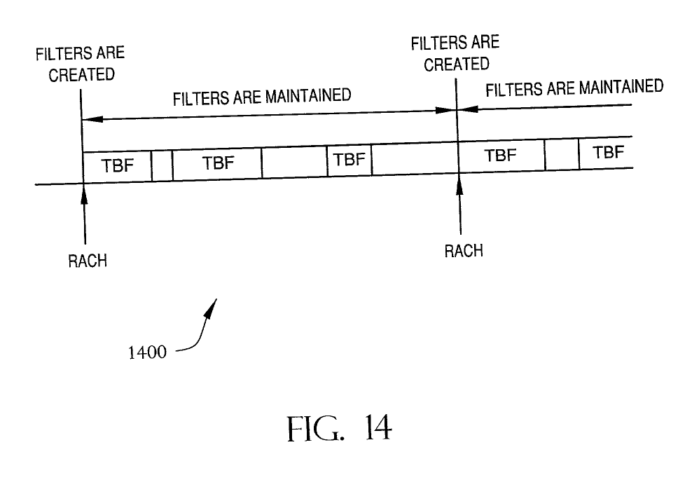

One filter is for SQM value and the other filter is for PAN value. These filters are created when the network receives a successful RACH message from the corresponding UT 104 and maintained until a next successful RACH is received from the same UT 104 by the SAS 102. FIG. 14 shows the establishment of the filters in diagram 1400.

It should be noted that the two filters should be preferably synchronized exactly. In other words, the two filters are established and torn down at the same time. Also, note that the coefficients of these two filters, β, are the same as shown in the two previous equations.

In order to determine the PAR duration, the most important driving criterion is whether or not the network collects enough status data to change the power level of the UT 104. If the network creates a PAR without enough observations, the closed loop power control algorithm can be oscillated due to the influence from the short-term channel variations.

To obtain enough confidence in the power level change, the criterion is established, firstly, at the point of the PAR calculation—the network should have at least 95.5% confidence in the new PAR. 95.5% is the 2σ value of the Gaussian distribution.

Considering that 0.4 dB is the step size of the PAR value, an incorrect PAR can be created when an error is over 0.2 dB. The above statement is equivalent to “the measurement error should be lower than 0.2 dB with 95.5% of confidence level”. Therefore, the standard deviation, σ, of the measurement error should be less than 0.1 dB. From monitoring a single burst, the standard deviation of the measurement error is less than 0.4 dB. Assuming that the measurement error is i.i.d (independent and identically distributed), the number of measurements required to achieve the 0.1 dB measurement error can be calculated with the following equation:

σ_{avg}×\sqrt{n}=σ_{sgr} (15)

where σ_{avg} is for measurement error throughout the observation of n bursts and σ_{sgl} is for the measurement error from the single burst. Therefore, the required number of bursts can be calculated with the following equation:

$$n = {( \frac{{σ}_{sgl}}{{σ}_{avg}} )}^{2} = {( \frac{0.4}{0.1} )}^{2} = 16 \qquad ( 16 )$$

At least 16 bursts are requited to achieve the objective. Considering that each return link burst is not perfectly identified, 20 bursts are chosen for the number of bursts required for achieving the objective in the satellite system 100.

In order to calculate the PAR duration, the assumption that 20 users exist in a subband on average is made. With this assumption, the network requires two seconds to collect 20 bursts in general. Therefore, the PAR duration is selected as 2 seconds. The target of the return link power control algorithm is that the algorithm should respond to the long-term change of the channel condition and that the algorithm should not react to the short-term channel variation.

The coefficient of the filters determines the speed of the averaging procedure. Using a relatively small value for the coefficient, the filter may eliminate the short-term channel variation, but the speed of the reaction for the long-term channel change is slow. Using a relatively large value for the coefficient, the algorithm can respond to the long-term channel variation more quickly. However, the short-term channel variation most significantly influences the algorithm.

There are three sources of signal quality variation for the return link burst, a change of the channel condition; an inaccurate measurement of the UT's 104 transmitted power level; and, incorrect decision made at the initial code rate selection. Assuming the Additive White Gaussian Noise (AWGN), the channel variation should not be the major driving parameter for design of the filter coefficient. Although the absolute TX accuracy of the normal bursts varies from 0 to 2 (dB) respect to the TX power level in ETSI document GMR-1 05.505, which is incorporated herein by reference, the relative TX accuracy, which is the power level variance between two consecutive burst, should be very small. Therefore, the relative TX accuracy also should not be the driving criteria for the design of the filter coefficient.

The code rate selection is preferably performed during the beginning of the TBF. After a code rate is selected, it remains unchanged during an entire TBF duration. Thus, if the code rate is selected incorrectly, it will largely impact the performance of the return link power control.

The maximum error due to the incorrect code rate assignment occurs when the maximum (minimum) code rate is assigned at the condition that the minimum (maximum) condition should be assigned. Considering that the target operating point for the minimum code rate is 3.5 dB and that of the maximum code rate is 6.1 (dB), the corresponding UT's 104 should operate with about 2.6 dB (=6.1−3.5) less link margin.

This miscalculation is due to the incorrect code rate assignment that should be adjusted at the next PAR calculation, which is 2 second after the code rate selection. Since the quantization level of the PAR value is 0.4 dB, the following is the criterion to select the filter coefficient:

At the next PAR calculation point, the coefficient of the averaging filter should be determined such that it eliminates the error due to the incorrect code rate selection. In order to achieve the above goal, the averaging values should reach the new value with less than 0.2 (dB) error at the next PAR calculation point. In other words, the averaging value should reach the 93% (=1−(0.2/2.6)) of the new value. A sudden change of the input values can be modeled as the unit step function 502 shown in FIG. 5.

Applying the step input at N samples, then the equation (10) will be:

$$\begin{matrix}{SQM}_{new\_avg} = β + β ( 1 - β ) + {β ( 1 - β )}^{2} + {β ( 1 - β )}^{3} + … + \\ {β ( 1 - β a )}^{N - 1} \\ = β \{ ( 1 - {( 1 - β )}^{N - 1} ) / ( 1 - ( 1 - β ) ) \} = \\ 1 - ( 1 - {( 1 - β )}^{N - 1}\end{matrix} \qquad ( 17 )$$

In order for the SQMnew_avg to be the 93% of the new value, the equation (14) should be:

0.93=1−(1−β)^{N-1} (18)

Therefore, the coefficient, β, should be as follows:

β=0.07−(0.1)^{(1/(n-1))} (19)

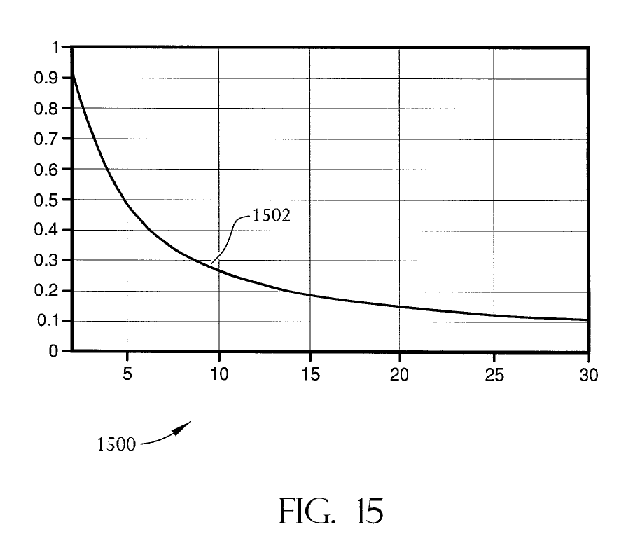

FIG. 15 shows β versus various N values at plot 1502. Since the power control duration is 2 seconds and about 20 return link bursts can be collected on average during the corresponding timeframe, the coefficient of the recursive filter for the SQM and PAN is selected as 0.13.

Conclusively, the coefficient of the recursive filter of the SQM as well as PAN are selected as follows:

$$\begin{matrix}β = 1 , & if {SQM}_{old\_avg} does not exist \\ = 0.13 , & Otherwise . \end{matrix} \qquad ( 20 )$$

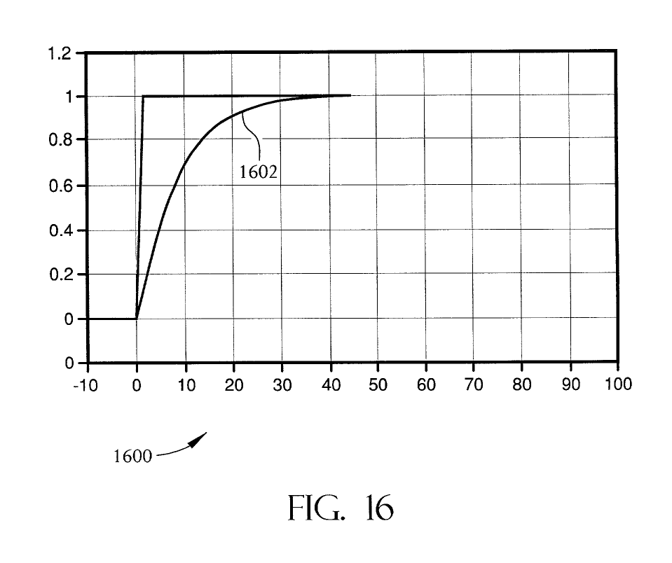

With a 0.13 coefficient, FIG. 16 shows the response of the filter to the unit step input at 0 point in plot 1602 it can be seen that the average value reaches 93% of the unit step response at the 20-samples point.

After the network calculates a PAR value, the value is transmitted to the corresponding UT 104. Basically, a PAR message is carried on the MAC/RLC hearder of a forward link burst. However, it is possible that the forward traffic burst is not available when a network creates a PAR value. A PACCH message to convey a PAR value will be created by the network preferably when the following two criterions are simultaneously met. First, the downlink burst is not available within 3 frames duration (120 msec) after the network calculates a new PAR value. Second, the difference between the new PAR value and the previous PAR value is greater than or equal to 2 step sizes of the PAR quantization, which is 0.8 dB.

The preferred system uses three coding schemes designated here by r₁=¾, r₂=⅝, and r₃=½ using k=7 convolutional codes. The user rates and nominal average E_{bt}/N₀ associated with the nominal operating link conditions, over a 5* 31.25=156.25 kHz PDCH at the three coding rates, are given Table 3 below.

TABLE 3

| Coding Scheme | User Rate (Kbps) | Target E_{bt}/N₀ (dB) |
|---|---|---|
| r₁ = 3/4 | 148.8 | (E_{bt}/N₀)₁ = TOP₁ = 6.1 + δ₁ |
| r₂ = 5/8 | 124.8 | (E_{bt}/N₀)₂ = TOP₂ = 5.1 + δ₂ |
| r₃ = 1/2 | 99.2 | (E_{bt}/N₀)₃ = TOP₃ = 3.5 + δ₃ |

As shown in the above table, the maximum user throughput and minimum delay performance objectives can be achieved by choosing the coding scheme that provides the maximum user rates and minimum retransmissions, within the limits of the power available. The transmit power needed by the UT to achieve the user rate associated to a particular coding rate is related to the E_{bt}/N₀. The last column of the table shows the Target Operating Point (TOP) for each code rate. Adjustable parameters of the target operating points, δ, in the table is set to zero by default. However, these numbers shall be configurable by the SAS, so that the target operating point of each code rate can be configurable in the future according to the field data collected in the real operating environment.

The power transmitted by the terminal can be change to a resolution of 0.4 dB. The level of attenuation in dBs below the UT's 104 maximum power level is sent to the SAS 102 in a parameter designated as PAN.

The decision for the power level adjustment, calculating the PAR value, is made every 2 seconds. The SAS 102 performs the following operations for adaptation of the return link power level:

Calculates the range as follow:

Range=(SQM)_{new}_{_{—}}_{avg}+(PAN)_{avg} (dB) (21)

the SAS 102 calculates the PAR from the range to represent (E_{bt}/N₀) of each code rate as follows:

PAR=Range−(E_{bt}/N₀)_{target} (dB) (22)

Sends the PAR message to the corresponding UT 104.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, specification and the following claims.

What is claimed is:

1. A method for managing a communications link, the method comprising the steps of:
continuously monitoring a quality parameter of the link, the link providing a satellite-based packet data service to a user terminal;
reducing a short-term sensitivity of the quality parameter such that a modified quality parameter results; and
adapting an operating parameter of the link based on the modified quality parameter.

2. The method of claim 1 further including the step of obtaining a signal quality indicator report (SQIR) for a forward link, the SQIR characterizing a forward link channel quality where the forward link transfers packet data to the user terminal.

3. The method of claim 2 further including the steps of:
receiving a burst from a reverse link where the reverse link transfers packet data from the user terminal; and
extracting an instantaneous SQIR from the burst, the SQIR being based on the instantaneous SQIR.

4. The method of claim 3 further including the step of receiving a traffic burst from the reverse link.

5. The method of claim 3 further including the step of receiving a control burst from the reverse link.

6. The method of claim 2 further including the step of filtering the SQIR in accordance with a filter coefficient.

7. The method of claim 2 further including the step of adapting a power level of the forward link.

8. The method of claim 2 further including the step of adapting a code rate of the forward link.

9. The method of claim 1 further including the step of obtaining a power attenuation notification (PAN) of a reverse link, the PAN characterizing a reverse link channel quality where the reverse link transfers packet data from the user terminal.

10. The method of claim 9 further including the steps of:
receiving a traffic burst from the reverse link;
extracting an instantaneous PAN from the traffic burst; and
generating an instantaneous signal quality measure (SQM) for the burst such that the instantaneous SQM represents an average signal quality for the traffic burst.

11. The method of claim 10 further including the steps of:
filtering the PAN in accordance with a filter coefficient; and
filtering the SQM in accordance with the filter coefficient.

12. The method of claim 9 further including the step of adapting a power level of the reverse link.

13. The method of claim 12 further including the step of transmitting a power attenuation request (PAR) over a forward link where the forward link transfers packet data from to the user terminal.

14. The method of claim 9 further including the step of adapting a code rate of the reverse link.

15. The method of claim 1 further including the step of repeating the monitoring, reducing and adapting steps for a plurality of user terminals within a coverage area of a geosynchronous satellite.

16. The method of claim 14 further including the step of repeating the monitoring, reducing and adapting steps for a plurality of geosynchronous satellites within a satellite-based communications network.

17. A method for participating in a communications link, the method comprising the steps of:
receiving a power attenuation request (PAR) from a forward link, where the forward link transfers packet data from a satellite-based network;
adjusting a transmitted power level based on the PAR; and
transmitting a power attenuation notification (PAN) over a reverse link, where the reverse link transfers packet data to the satellite-based network.

18. The method of claim 17 further including the step of transmitting the PAN over a traffic burst of the reverse link.

19. A method for participating in a communications link, the method comprising the steps of:
receiving bursts from a forward link where the forward link transfers packet data from a satellite-based network;
generating a signal quality measure (SQM) such that the SQM characterizes a forward link channel quality; and
transmitting a signal quality indicator report (SQIR) over a reverse link based on the SQM where the reverse link transfers packet data to the satellite-based network.

20. The method of claim 19 further including the steps of:
calculating instantaneous SQMs for the received bursts; and
averaging the instantaneous SQMs.

21. The method of claim 19 further including the steps of:
encoding the SQM into the SQIR; and
converting the SQIR into a binary format.

22. A method for managing a plurality of communications links with a satellite communications network, the method comprising the steps of:
continuously monitoring quality parameters of the links, the links providing a satellite-based packet data service to a plurality of user terminals within a coverage area of one or more geosynchronous satellites;
reducing a short-term sensitivity of the quality parameters such that modified quality parameters result;
adapting operating parameters of the links based on the modified quality parameters;
the monitoring step including the steps of:
obtaining signal quality indicator reports (SQIRs), the SQIRs characterizing a forward link channel quality where the forward links transfer packet data from the network to the user terminals; and
obtaining power attenuation notifications (PANs), the PANs characterizing a reverse link channel quality where the reverse links transfer packet data from the user terminals to the network.

23. The method of claim 22 further including the steps of:
adapting power levels of the forward and reverse links; and
adapting code rates of the forward and reverse links.

24. The method of claim 22 further including the steps of:
receiving bursts from the reverse links; and
extracting instantaneous SQIRs from the bursts, the SQIRs being based on the instantaneous SQIRs.

25. The method of claim 22 further including the steps of:
receiving traffic bursts from the reverse links;
extracting instantaneous PANs from the traffic bursts; and
generating instantaneous signal quality measures (SQMs) for the bursts such that the instantaneous SQMs represent an average signal quality for the traffic bursts.

26. A satellite access station comprising:
a packet base station subsystem for monitoring quality parameters of a plurality of communications links, the links providing a satellite-based packet data service to a plurality of user terminals within a coverage area of one or more geosynchronous satellites;
a network switching subsystem providing a switching interface between the packet base station subsystem and a packet-switched network;
said packet base station subsystem adapting operating parameters of the links based on the quality parameters.

27. The access station of claim 26 wherein the access station maintains a wireless feederlink interface with a satellite payload.
